(19) United States
(12) Patent Application Publication
(10) Pub. No.: US 2004/0150226 A1
(43) Pub. Date: Aug. 5, 2004

(54) Arrangement for assembly of pipe flanges, comprising spacers positioned between the pipe flanges

(76) Inventor: Ann Helen Hystad, Kopervik (NO)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/476,125

(22) PCT Filed: Apr. 19, 2002
(86) PCT No.: PCT/NO02/00146

(30) Foreign Application Priority Data
Apr. 26, 2001 (NO) 20012041

(51) Int. Cl. F16L 17/00

(52) U.S. Cl. 285/368

(57) ABSTRACT

An arrangement at pipe flange connections (1) of the type in which the flange halves (2, 4) of the pipe connection (1) are squeezed together by means of screw-bolt joints (8) during assembly, and where one or more spacers (18) are positioned between the pipe flange halves (2, 4).

This invention regards an arrangement for preventing uneven tightening during the assembly of pipe flange halves

A considerable share of all failures in the form of material damage and leaks in pipe flange connections are caused by uneven tightening of the flange halves.

Many standardised flange designs, e.g. according to American National Standards Institute ANSI and the International Standardisation Organisation ISO, show flange halves having a stepped sealing side. Thus the sealing part of the flange half, which is constituted by an annular area most proximal to the through central opening of the flange half, is located in a plane that is drawn slightly out relative to the rest of the end face of the flange half.

When the flange connection is screwed together correctly, flange designs of the type described above also have, in the annular area located radially outward of the sealing area of the flange half , hereinafter termed the clearance area, a clearance of several millimetres between the flange halves.

The sealing material in flange connections, which may be composed of a metal or fibrous material, is squeezed together between the sealing parts of the flange halves by means of screw-bolt joints according to prior art.

With a few exceptions, flange halves are connected to their respective pipes by means of a welding connection or screw connection, or they may form part of e.g. a cast valve body.

When a flange connection is to be assembled, the seal is placed between the sealing areas of the flange halves, whereupon the screw-bolt joints are fitted and tightened. In order to achieve a tight and undamaged flange connection, it is crucial for the sealing surfaces of the flange halves to is be positioned in and remain in parallel planes. It is obvious that if one of the screw-bolt joints is tightened too far, so that the distance between the flange halves in the clearance area by the screw-bolt joint in question is less than a predetermined value for a ready assembled and tightened flange connection, the sealing areas of the flange halves and that part of the seal located closest to the screw-bolt joint in question will be overloaded when the screw-bolt-joint on the diametrically opposite side of the flange connection is tightened to the correct clearance.

Misaligned or uneven tightening of flange connections may also cause breaks and leakage in the welded connections of the flange halves, along with deformation of the associated piping.

The object of the invention is to remedy the disadvantages of prior art.

The object is achieved in accordance with the invention by the characteristics stated in the undermentioned description and in the appended claims.

For most standardised flange connections, the required clearance between flange halves in the clearance area is stated placing spacers, usually in the form of a ring encircling the shaft of the screw-bolt joint, between the flange halves prevents the bolt halves being tightened too much. Thus damage and leaks may be prevented. Even though it may not be favourable to tighten a flange connection to the correct clearance at one screw-bolt joint and then tighten the remaining screw-bolt joints, use of the arrangement according to the invention still entails a far smaller risk of damage and leaks.

The following describes a non-limiting example of a preferred embodiment illustrated in the accompanying drawings, in which;

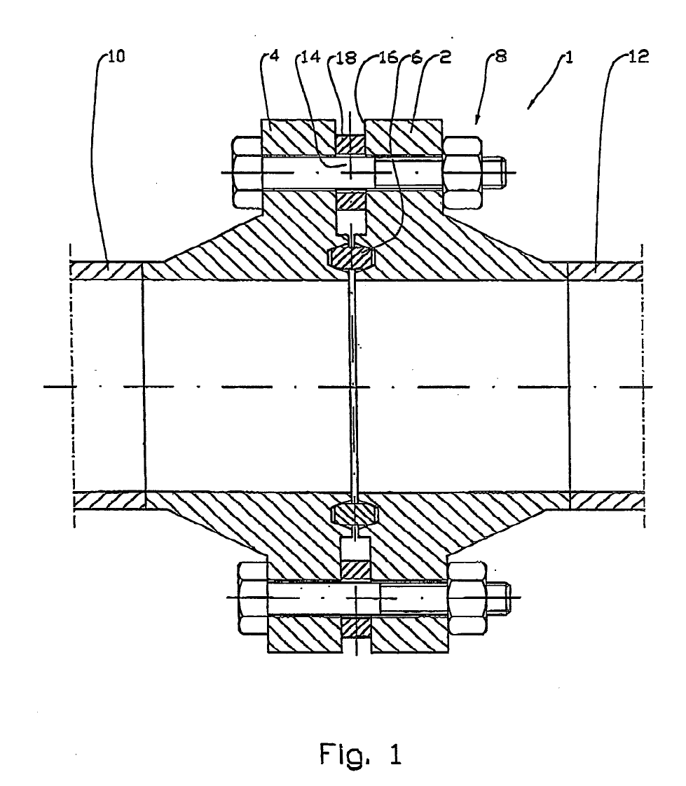

FIG. 1 shows a sectional view of a flange connection in which spacers are provided in the clearance area between the flange halves.

In the drawing, reference number 1 denotes a flange connection comprising two flange halves 2 and 4, a seal 6 and screw-bolt joints 8. The flange halves 2 and 4 are sealingly connected to their respective pipes 10 and 12 by welding connections.

Spacers 18 are positioned in an encircling manner around the shaft 14 of the screw-bolt joint 8 in a clearance area 16 between the flange halves 2 and 4. The thickness of the spacers 18 corresponds to the clearance specified for the type and dimension of flange connection 1 in question in the relevant clearance area 16.

The flange halves 2 and 4 of FIG. 1 are connected to pipes 10 and 12. The arrangement is equally suited for flange halves forming part of e.g. a cast valve body (not shown).

When tightening the flange connection 1, it is not possible to tighten the flange halves 2 and 4 to a clearance in the clearance area. 16 which is less than the predetermined value. The spacer 18 constitutes a protection for the shaft 14 of the screw-bolt joint 8, e.g. against corrosion.

1. An arrangement at pipe flange connections (1) of the type in which the flange halves (2, 4) of the pipe connection (1) are squeezed together by means of screw-bolt joints (8) during assembly, and where a detachable metal ring (6) constitutes the sealing element, characterised in that one or more spacers (18) are positioned between the pipe flange halves (2, 4).

2. An arrangement in accordance with claim 1, characterised in that the thickness of the spacers (18) corresponds to the predetermined clearance of the flange connection (1).

3. An arrangement in accordance with on or more of the preceding claims, characterised in that the spacers (18) are constituted by sleeves encompassing the shafts (14) of the screw-bolt joints (8).
